(19) United States
(12) Patent Application Publication
(10) Pub. No.: US 2020/0112149 A1
(43) Pub. Date: Apr. 9, 2020

(54) Fish Tape Roller Head

(71) Applicant: James Dunn, Max Meadows, VA (US)

(72) Inventor: James Dunn, Max Meadows, VA (US)

(21) Appl. No.: 16/155,263

(22) Filed: Oct. 9, 2018

(51) Int. Cl. H02G 1/08

(52) U.S. Cl. CPC H02G 1/083; H02G 1/088; H02G 1/085

(57) ABSTRACT

A fish tape roller head for guiding fish tape through a conduit includes a head body having a top side, a bottom side, a back side, and a right arm and a left arm forming a U-shaped front side. Each of the right arm and the left arm have an axle aperture extending through from an outside edge to an inside edge. The back side has a threaded aperture extending towards the front side that is configured to receive a fish tape. An axle is coupled to the head body by being coupled through the axle aperture of each of the right and the left arm and extending therebetween. A spherical rollerball is coupled to the axle and has a through hole axially extending therethrough. The through hole receives the axle such that the rollerball is rotatable around the axle between the right arm and the left arm.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to fish tape guides and more particularly pertains to a new fish tape guide for guiding fish tape through a conduit.

### BRIEF SUMMARY OF THE INVENTION

An embodiment of the disclosure meets the needs presented above by generally comprising a head body having a top side, a bottom side, a back side, and a right arm and a left arm forming a U-shaped front side. Each of the right arm and the left arm have an outside edge, an inside edge, and an axle aperture extending through from the outside edge to the inside edge. The back side has a threaded aperture extending towards the front side that is configured to receive a fish tape. An axle is coupled to the head body by being coupled through the axle aperture of each of the right and the left arm and extending therebetween. A spherical rollerball is coupled to the axle and has a through hole axially extending therethrough. The through hole receives the axle such that the rollerball is rotatable around the axle between the right arm and the left arm.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a fish tape roller head according to an embodiment of the disclosure.

FIG. 2 is a bottom plan view of an embodiment of the disclosure.

FIG. 3 is a side elevation view of an embodiment of the disclosure.

FIG. 4 is a rear elevation view of an embodiment of the disclosure.

FIG. 5 is a front elevation view of an embodiment of the disclosure.

FIG. 6 is an in-use view of an embodiment of the disclosure.

### DETAILED DESCRIPTION OF THE INVENTION

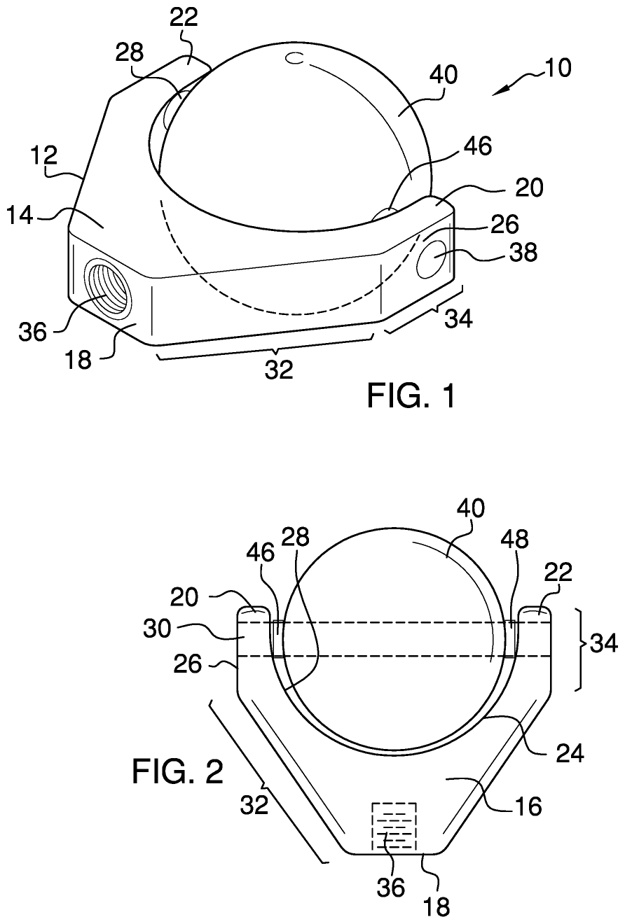

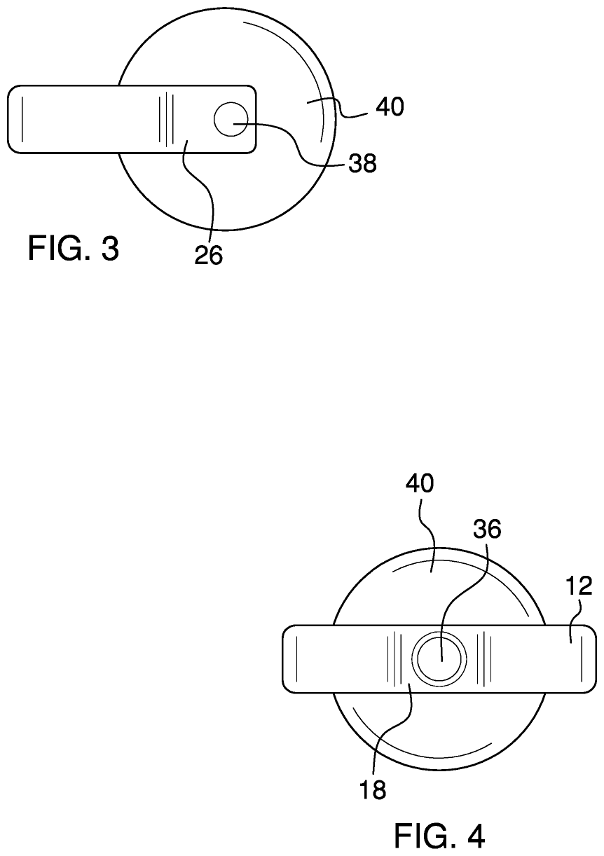

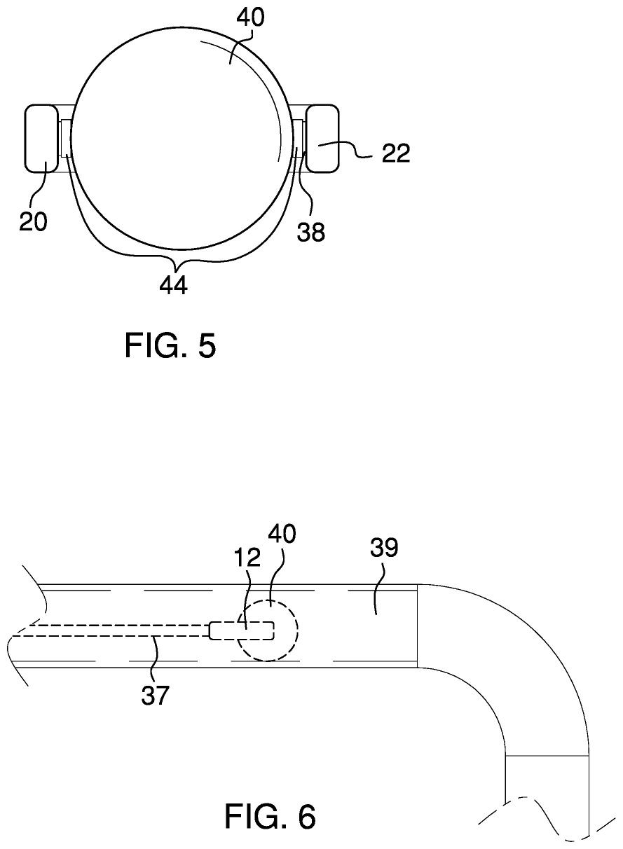

With reference now to the drawings, and in particular to FIGS. 1 through 6 thereof, a new fish tape guide embodying the principles and concepts of an embodiment of the disclosure and generally designated by the reference numeral 10 will be described.

As best illustrated in FIGS. 1 through 6, the fish tape roller head 10 generally comprises a head body 12 having a top side 14, a bottom side 16, a back side 18, and a right arm 20 and a left arm 22 forming a U-shaped front side 24. Each of the right arm 20 and the left arm 22 have an outside edge 26, an inside edge 28, and an axle aperture 30 extending through from the outside edge 26 to the inside edge 28. The outside edge 26 of each of the right arm and the left arm may comprise an angled facet 32 and a perpendicular facet 34 with the angled facet 32 extending from the back side 18 at an angle and the perpendicular facet 34 extending from the angled facet 32 perpendicular to the back side 18. The back side 18 has a threaded aperture 36 extending towards the front side 24 that is configured to receive a fish tape 37. By screwing the fish tape 37 directly into the threaded aperture 36 it remains balanced while passing throughout a conduit 39 and will not get caught on other wires as when fish tape is taped to other guide heads. An axle 38 is coupled through the axle aperture 30 of each of the right and the left arm and extends therebetween. A spherical rollerball 40 is coupled to the axle 38 and has a through hole 42 axially extending therethrough. The through hole 42 receives the axle 38 such that the rollerball 40 is rotatable around the axle 38 between the right arm 20 and the left arm 22. There may be a pair of spacers 44 comprising a right spacer 46 and a left spacer 48. The right spacer 46 is coupled around the axle 38 between the inside edge 28 of the right arm and the rollerball 40 and the left spacer 48 is coupled around the axle 38 between the inside edge 28 of the left arm and the rollerball 40. The pair of spacers 44 prevents the rollerball 40 from contacting the U-shaped front side 24 of the head body.

In use, fish tape is screwed into the threaded aperture 36 of the head body 12. The fish tape roller head 10 is then placed into the conduit with the spherical rollerball 40 leading and gliding over other wires and around bends in the conduit 39.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fish tape roller head comprising:
a head body having a top side, a bottom side, a back side, and a right arm and a left arm forming a U-shaped front side, each of the right arm and the left arm having an outside edge, an inside edge, and an axle aperture extending through from the outside edge to the inside edge, the back side having a threaded aperture extending towards the front side, the threaded aperture being configured to receive a fish tape;
an axle coupled to the head body, the axle being coupled through the axle aperture of each of the right and the left arm and extending therebetween; and
a rollerball coupled to the axle, the rollerball being spherical and having a through hole axially extending therethrough, the through hole receiving the axle such that the rollerball is rotatable around the axle between the right arm and the left arm.

2. The fish tape roller head of claim 1 further comprising a pair of spacers comprising a right spacer and a left spacer, the right spacer being coupled around the axle between the inside edge of the right arm and the rollerball and the left spacer being coupled around the axle between the inside edge of the left arm and the rollerball.

3. The fish tape roller head of claim 1 further comprising the outside edge of each of the right arm and the left arm comprising an angled facet and a perpendicular facet, the angled facet extending from the back side of the head body at an angle and the perpendicular facet extending from the angled facet perpendicular to the back side.

4. A fish tape roller head comprising:
a head body having a top side, a bottom side, a back side, and a right arm and a left arm forming a U-shaped front side, each of the right arm and the left arm having an outside edge, an inside edge, and an axle aperture extending through from the outside edge to the inside edge, the outside edge of each of the right arm and the left arm comprising an angled facet and a perpendicular facet, the angled facet extending from the back side at an angle and the perpendicular facet extending from the angled facet perpendicular to the back side, the back side having a threaded aperture extending towards the front side, the threaded aperture being configured to receive a fish tape;
an axle coupled to the head body, the axle being coupled through the axle aperture of each of the right and the left arm and extending therebetween;
a rollerball coupled to the axle, the rollerball being spherical and having a through hole axially extending therethrough, the through hole receiving the axle such that the rollerball is rotatable around the axle between the right arm and the left arm; and
a pair of spacers comprising a right spacer and a left spacer, the right spacer being coupled around the axle between the inside edge of the right arm and the rollerball and the left spacer being coupled around the axle between the inside edge of the left arm and the rollerball.

5. A fish tape and fish tape roller head combination comprising:
a fish tape, the fish tape having a threaded end;
a head body having a top side, a bottom side, a back side, and a right arm and a left arm forming a U-shaped front side, each of the right arm and the left arm having an outside edge, an inside edge, and an axle aperture extending through from the outside edge to the inside edge, the outside edge of each of the right arm and the left arm comprising an angled facet and a perpendicular facet, the angled facet extending from the back side at an angle and the perpendicular facet extending from the angled facet perpendicular to the back side, the back side having a threaded aperture extending towards the front side, the threaded aperture receiving the threaded end of the fish tape;
an axle coupled to the head body, the axle being coupled through the axle aperture of each of the right and the left arm and extending therebetween;
a rollerball coupled to the axle, the rollerball being spherical and having a through hole axially extending therethrough, the through hole receiving the axle such that the rollerball is rotatable around the axle between the right arm and the left arm; and
a pair of spacers comprising a right spacer and a left spacer, the right spacer being coupled around the axle between the inside edge of the right arm and the rollerball and the left spacer being coupled around the axle between the inside edge of the left arm and the rollerball.
